(19) United States
(12) Patent Application Publication
(10) Pub. No.: US 2023/0385859 A1
(43) Pub. Date: Nov. 30, 2023

(54) INTELLIGENTLY COMBINING RELEVANT DATA ITEMS OF REQUESTED DATA SETS DURING INGESTION

(71) Applicant: Qualtrics, LLC, Provo, UT (US)

(72) Inventors: Evan Paul Child, Provo, UT (US); Vernon W. Hui, Bellevue, WA (US); Kenyon Porter, South Jordan, UT (US)

(21) Appl. No.: 18/322,180

(22) Filed: May 23, 2023

Related U.S. Application Data
(60) Provisional application No. 63/365,184, filed on May 23, 2022.

(51) Int. Cl. G06Q 30/0203

(52) U.S. Cl. CPC G06Q 30/0203

(57) ABSTRACT

The present disclosure relates to systems, non-transitory computer-readable media, and methods for intelligently generating an efficient new data set for storage in non-temporary storage during ingestion of other inefficient data sets. In particular, in one or more embodiments, the disclosed systems ingests a subset of a second data set of operational data items along with a first data set of response data items based on correlations between the subset of operational data items and the response data items. Thus, the disclosed systems provide a robust solution to efficiently ingesting data sets while avoiding computing storage and processing waste.

### CROSS-REFERENCE TO RELATED APPLICATIONS

This application claims the benefit of and priority to U.S. Provisional Application No. 63/365,184, filed on May 23, 2022. The aforementioned application is hereby incorporated by reference in its entirety.

### BACKGROUND

Recent years have seen significant improvements in data analysis. For example, conventional systems can analyze digital data for various outcomes. To illustrate, conventional systems digital data to generate one or more insights. Conventional systems perform such analysis to, for example, identify trends, determine target users, and recommend other actions.

Although conventional systems can receive, store, and analyze digital data, such systems have a number of problems in relation to accuracy, efficiency, and flexibility of operation. For instance, in response to receiving a request to ingest one or more data sets, conventional systems adhere to rigid ingestion methodologies. These methodologies funnel requested data sets wholesale into permanent data storage—regardless of whether data items in those data sets are relevant to desired analytical outcomes.

Additionally, conventional systems inefficiently utilize computing resources. For example, as just mentioned, conventional systems funnel specified data sets into one or more repositories regardless of what those data sets include. Accordingly, conventional systems waste computing resources in storing data items that are potentially irrelevant to further analyses. Conventional systems then waste further computing resources (e.g., processor resources) in analyzing such irrelevant data items.

Furthermore, conventional systems are inaccurate. For example, by storing and analyzing potentially irrelevant data items from requested data sets, conventional systems generate inaccurate analytical results based on those irrelevant data items. To illustrate, conventional systems funnel a full data set into a storage repository, even when that data set includes data items that are tied to a wide range of dates, users, responses, and so forth. Accordingly, in response to an analytical task drawn to, for example, a specific date, conventional systems generate inaccurate results based on all data items stored in the repository—including those data items associated with other dates.

To overcome these inaccuracies, conventional systems typically offer only difficult and complex analytical tools accessible via multiple user interfaces. These user interfaces generally require excessive user interactions to code and format data queries, as well as other executables that circumvent or otherwise disregard the irrelevant data items during analysis of the relevant data items. By requiring a high amount of user interactions with multiple user interfaces, conventional systems waste additional computer resources (e.g., processing and memory resources to generate, initialize, and switch between displays and applications) while attempting to overcome the inaccuracies generated by such irrelevant data items.

These along with additional problems and issues exist with regard to conventional systems.

### BRIEF SUMMARY

One or more embodiments, described herein provide benefits and/or solve one or more of the foregoing or other problems in the art with systems, methods, and non-transitory computer readable media that generate an intelligently merged data set during data ingestion that includes relevant and usable data items from various data sets. For instance, the disclosed systems combine two or more data sets during ingestion (e.g., prior to moving the data sets to non-temporary storage) according to one or more criteria that effectively filter out data items that are not usable in further analysis. As such, the disclosed systems streamline and improve data ingestion and later analysis by combining relevant and usable data items from requested data sets while funneling the corresponding data sets into non-temporary storage, and disregarding data items that do not correspond with one or more specified criteria.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which an intelligent data ingestion system can operate in accordance with one or more embodiments.

FIG. 2 illustrates an overview schematic of the intelligent data ingestion system generating a new data set during ingestion of other data sets in accordance with one or more embodiments.

FIG. 3 illustrates a schematic diagram of the intelligent data ingestion system generating a third data set including response data items of a first data set and a subset of operational data items of a second data set.

FIG. 4 illustrates a schematic diagram of performing additional operations including date calculations, value mapping, and arithmetic operations in connection with a joined data item of the generated third data set.

FIG. 5A-5J illustrate an intelligent data ingestion system generating and providing an ingestion configuration user interface for configuring the generation of a new data set during data ingestion in accordance with one or more embodiments.

FIG. 6 illustrates a schematic diagram of the intelligent data ingestion system in accordance with one or more embodiments.

FIG. 7 illustrates a flowchart of a series of acts for generating a third data set for non-temporary storage during ingestion of a first data set of response data items and a second data set of operational data items in accordance with one or more embodiments.

FIG. 8 illustrates a block diagram of a computing device in accordance with one or more embodiments.

FIG. 9 illustrates a networking environment of an intelligent data ingestion system in accordance with one or more embodiments.

### DETAILED DESCRIPTION

This disclosure describes one or more embodiments of an intelligent data ingestion system that, during data ingestion, combines data items from two or more data sets that correspond with one or more criteria to generate a new data set of relevant data items for non-temporary storage and further analysis. More specifically, the intelligent data ingestion system receives a request to ingest a data set of response data items associated with a digital survey (or other experience management data). The intelligent data ingestion system further receives a request to ingest a data set of operational data items that are relevant—at least in part—to the response data item. In one or more embodiments and during ingestion, the intelligent data ingestion system generates a new data set with experience management data items and operational data items that correlate across at least one specified index. Thus, by storing the generated new data set including the relevant data items, the intelligent data ingestion system efficiently utilizes computing resources by avoiding storage of data items that are untethered from other data items in the new data and irrelevant for further analysis.

To illustrate, the intelligent data ingestion system receives two or more data sets for ingestion into non-temporary data storage (e.g., a centralized data repository). For example, in one embodiment, the intelligent data ingestion system receives the two or more data sets in response to a request from a digital management experience sponsor to ingest the two or more data sets into non-temporary data storage. In one or more embodiments, the intelligent data ingestion system receives the two or more data sets as part of a file transfer (e.g., an FTP file transfer), and/or as self-contained files (e.g., a CSV file, a JSON file, a TSB file, a TSV file) and stages the two or more data sets in a temporary memory storage (e.g., a data lake, or other temporary storage).

In more detail, the intelligent data ingestion system receives at least one data set that includes response data items (e.g., from an electronic survey). For example, in one embodiment, the intelligent data ingestion system receives response data items from one or more servers associated with a digital survey sponsor. To illustrate, in at least one embodiment, response data items include digital survey information (e.g., a digital survey ID), digital survey question information (e.g., question IDs associated with a digital survey ID, question text from questions associated with a particular digital survey), digital survey response information (e.g., response IDs associated with a question ID, response text for the responses associated with questions of a particular digital survey), selected response information (e.g., a user ID associated with a survey-taker and selected response IDs), and so forth.

Additionally, in one or more embodiments, the intelligent data ingestion system receives at least one data set that includes operational data items. For example, the intelligent data ingestion system receives operational data items associated with the same digital survey sponsor that is associated with the received response data items. To illustrate, in at least one embodiment, operational data items include user information for users registered with the digital survey sponsor (e.g., profile information, contact information, corporate organizational information), transactional information (e.g., purchase information including transaction date, transaction amount), survey distribution statistics (e.g., users who received the digital survey versus users who responded to the digital survey), and so forth.

In at least one embodiment, the intelligent data ingestion system manages the process of intelligently ingesting the received data sets into non-temporary data storage. For example, rather than storing all the data items of the received data sets, the intelligent data ingestion system generates a new data set for storage that includes select data items that are targeted to specific criteria. To illustrate, in one embodiment, the intelligent data ingestion system identifies operational data items that correspond with the received response data items based on at least one index associated with the response data items and combine the identified operational data items with the received response data items within a new data set. The intelligent data ingestion system then stores the new data set including the received response data items along with the subset of the operational data items that correlate with the received response data items.

In one or more embodiments, the intelligent data ingestion system enables further transformations of the received data sets during data ingestion. For example, in at least one embodiment, the intelligent data ingestion system transforms data items prior to storage in a non-temporary data repository by: converting index values to a specified format, mapping indexes and/or index values to other values/character strings, or applying one or more arithmetic operations to index values. Additionally, in at least one embodiment, the intelligent data ingestion system generates the new data set of the combined response data items and operational data items according to one or more user selected data set fields or indices.

As mentioned above, the intelligent data ingestion system provides many advantages and benefits over conventional systems and methods. For example, as mentioned above, conventional systems are rigidly tied to traditional data methodologies that include storing entire data sets only to utilize a portion of those data sets in analysis. Contrary to this, the intelligent data ingestion system injects flexibility into the data ingestion pipeline by generating a new data set for storage that includes targeted data items instead of storing unabridged data sets. And because the creation of the new data set occurs as part of the data ingestion process, the intelligent data ingestion system provides a robust solution that avoids the need for further querying and data manipulation once the data sets are stored in a non-temporary data repository.

Additionally, the intelligent data ingestion system improves the computational efficiency of conventional systems and methods. For example, while conventional systems waste computing resources in storing and analyzing potentially irrelevant and unusable data items from ingested data sets, the intelligent data ingestion system ingests data items based on their correlations with each other—leading to storage of a new data set of targeted and specific data items. Thus, the intelligent data ingestion system saves memory resources by avoiding storage of unusable and untethered data items. The intelligent data ingestion system further improves the speed and efficiency of computer processing resources by confining analytical tasks to the intelligently selected data items in data storage, rather than wasting processing power in analyzing irrelevant data.

In saving computing resources, the intelligent data ingestion system also generates additional accuracies in analytical outcomes. For example, while conventional systems often engage in analytical tasks including potentially irrelevant data items, leading to inaccurate results based on those potentially irrelevant data items. Contrary to this, the intelligent data ingestion system avoids these inaccuracies by performing analytical tasks in connection with the targeted data items that are precise to various criteria indicated during ingestion. This, in turn, leads to more accurate analysis, predictions, and insights based on the data items of the new data set generated during ingestion.

Moreover, the intelligent data ingestion system generates other efficiencies and accuracies relative to conventional systems by providing a single user interface for specifying how the new data set is generated during ingestion. For example, as mentioned above, conventional systems allow for querying and transformation of one or more data sets via a variety of user interfaces that require excessive user interactions—and often an expert-level knowledge base of computer coding and database interactions—to successfully extract desired data items from data storage. Contrary to this, the intelligent data ingestion system introduces a streamlined user interface with a limited number of easy-to-understand controls, whereby a user can configure criteria for data item selection during data ingestion.

As illustrated by the foregoing discussion, the present disclosure utilizes a variety of terms to describe features and advantages of the intelligent data ingestion system. Additional detail is now provided regarding the meaning of such terms. For example, as used herein, the term “data set” refers to a collection of data items. In particular, the term data set can include data items from one or more sources. Additionally, a data set can exist in one or more formats. For example, a data set can be a comma-separated values file (e.g., a CSV file). Additionally or alternatively, a data set can be a linked list, a hash table, a text file (e.g., delimited by any specified character), or any other type of data file. In one or more embodiments, the intelligent data ingestion system receives data sets via file transfer (e.g., according to any of various protocols such as SFTP), or any other type of data transfer method.

As used herein, a “data item” refers to a member of a data set. For example, in one or more embodiments, a data item includes information across one or more indices, where the included information is relative to a particular topic, transaction, response, operation, etc. To illustrate, in one embodiment, a data set is a table of information with multiple columns, and a data item is a row in that table. In alternative embodiments, a data set is a collection of pointers and a data item is pointed to by one of the pointers in the data set.

As used herein, an “index” refers to a data category associated with a data item. In one or more embodiments, a data item has multiple indices. To illustrate, if a data item is a row in a data set table, an index of the data item is a column in that row. In at least one embodiment, the intelligent data ingestion system utilizes an index of multiple data items as a joint key. As used herein, an “index value” refers to data located at a particular index in a data item. For instance, a data item may include a “date” index, and the index value associated with that index is a specific date. Index values can include numbers, characters, text, pointers, encoded values, and so forth.

As used herein, a “schema” refers to a predetermined data organization outline. For example, a schema can include canonical index names, a specified index order, and acceptable index value formatting. In one or more embodiments, as discussed further below, the intelligent data ingestion system “schematizes” received data sets prior to combining targeted data items of those data sets into a new data set for preservation in non-temporary data storage. For example, in at least one embodiment, the intelligent data ingestion system schematizes a received data set by mapping non-canonical indices to canonical indices. For instance, in at least one embodiment, the intelligent data ingestion system maps non-canonical indices to canonical indices by modifying index titles, index orders, and/or index values in accordance with at least one schema.

As used herein, “response data items” refer to data items that are specific to at least one digital survey. For example, response data items may not include the same indices and index values. Instead, response data items include, but are not limited to, one or more of: question information associated with the one or more digital surveys, response information associated with the one or more digital surveys, user-selected responses associated with the one or more digital surveys, user information associated with users who responded to questions from the one or more digital surveys, deployment information associated with the one or more digital surveys, and question flow information associated with the one or more digital surveys.

As used herein, a “digital survey” refers to a digital collection of questions and associated responses. For example, in one embodiment, a digital survey includes digital question identifiers organized according to a specific question flow, where each question identifier refers to question text, question rules (e.g., “select all that apply,” “choose only one”), and is tied or mapped to various response identifiers. The response identifiers refer to response text, and are associated with a presentation order and other formatting. When a user completes a digital survey, one or more systems described herein generate one or more data items including information on the survey taker (e.g., a user ID, a survey completion timestamp), and information including the user's selected responses within the survey.

As used herein, “operational data items” refer to non-survey data items that correlated with or are otherwise connected to a sponsor of one or more digital surveys. In one or more embodiments, for example, the intelligent data ingestion system utilizes operational data items to enrich and add additional insights to the analysis of response data items. In at least one embodiment, response data items include, but are not limited to, profile information, contact information, corporate organization information, individual transaction date information, individual transaction user information, individual transaction amount information, and survey distribution statistics (e.g., users who received a digital survey, user who completed the digital survey, users who responded to a portion of the questions in the digital survey, amount of time taken to complete the digital survey).

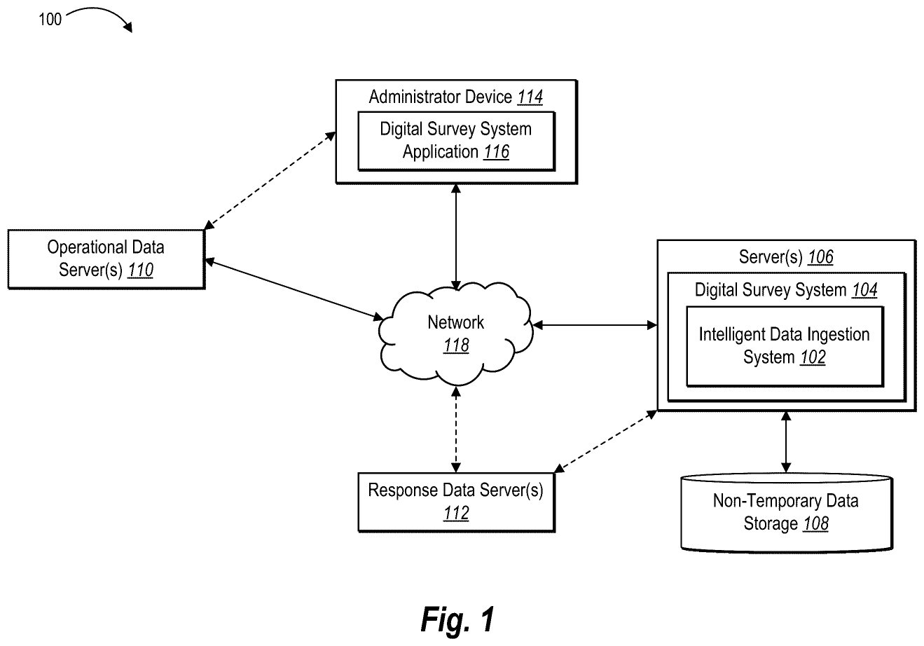

FIG. 1 illustrates an environment 100 in which an exemplary intelligent data ingestion system 102 may be implemented in accordance with one or more embodiments. As shown, the environment 100 includes the intelligent data ingestion system 102 operating within a digital survey system 104. For example, in one or more embodiments, the intelligent data ingestion system 102 and the digital survey system 104 are hosted by a server(s) 106. Moreover, as illustrated, the environment 100 also includes an administrator device 114, as well as an operational data server(s) 110 and a response data server(s) 112.

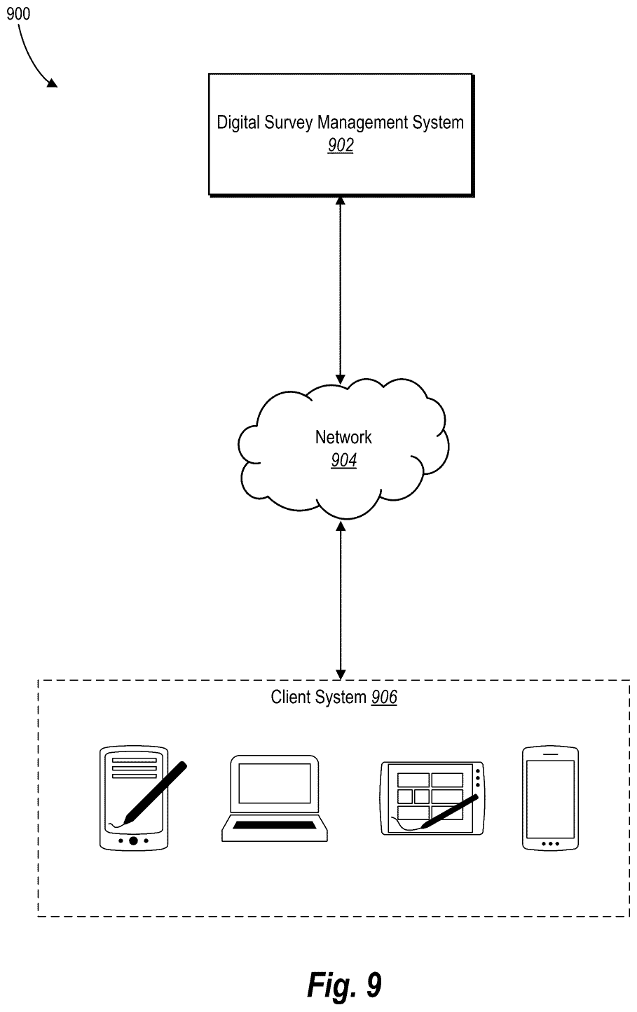

In one or more embodiments, the server(s) 106, the administrator device 114, the operational data server(s) 110, and the response data server(s) 112 communicate via the network 118, which may include one or more networks and may use one or more communication platforms or technologies suitable for transmitting data and/or communication signals. In one or more embodiments, the network 118 includes the Internet or World Wide Web. The network 118, however, can include various other types of networks that use various communication technologies and protocols, such as a corporate intranet, a virtual private network (“VPN”), a local area network (“LAN”), a wireless local network (“WLAN”), a cellular network, a wide area network (“WAN”), a metropolitan area network (“MAN”), or a combination of two or more such networks. Additional details relating to the network 118 are explained below with reference to FIG. 9.

As shown in FIG. 1, the environment 100 includes the digital survey system 104. In one or more embodiments, the digital survey system 104 includes various interfaces and storage repositories that enable a survey administrator to create and publish or distribute a digital survey, as well as receive and analyze responses to that digital survey. In at least one embodiment, the digital survey system 104 is implemented by the server(s) 106, which may generate, store, receive, and transmit any type of data. For example, the server(s) 106 may transmit data to and receive data from the administrator device 114 and/or the operational data server(s) 110 and response data server(s) 112. In one example embodiment, the server(s) 104 comprise one or more content servers. In additional or alternative embodiments, the server(s) 104 comprise one or more web-hosting servers.

Moreover, in one or more embodiments, the digital survey system 104 includes or hosts the intelligent data ingestion system 102. In one or more embodiments, the intelligent data ingestion system 102 accesses the digital survey system 104 to utilize data sets received from the operational data server(s) 110 and/or the response data server(s) 112 prior to ingesting at least a subset of the received data sets into a non-temporary data storage 108. In at least one embodiment, the intelligent data ingestion system 102 ingests the subset of the received data sets according to criteria configured by and/or received from the administrator device 114.

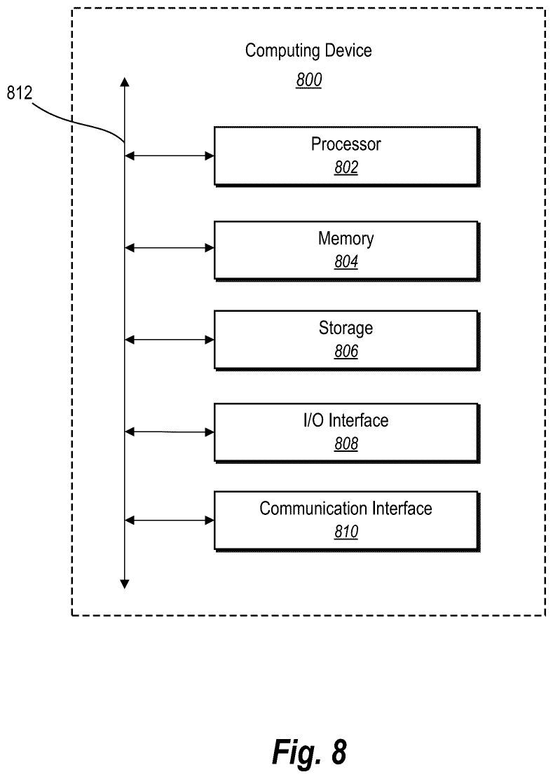

In one or more embodiments, the administrator device 114 can be one of various types of computing devices. For example, the administrator device 114 may include a mobile device such as a mobile telephone, a smartphone, a PDA, a tablet, or a laptop. Additionally, or alternatively, the administrator device 114 may include a non-mobile device such as a desktop computing, a server, or another type of computing device. In at least one embodiment, the administrator device 114 accesses the intelligent data ingestion system 102 and/or the digital survey system 104 via a web browser or a native digital survey system application 116 installed thereon. Additional information regarding the administrator device 114 is discussed below with regard to FIG. 8.

As shown in FIG. 1, the environment 100 includes the operational data server(s) 110 and the response data server(s) 112. In one or more embodiments, the operational data server(s) 110 store and provide operational data items associated with the administrator device 114. For example, in one embodiment, the administrator device 114 is associated with a corporation including a number of employees. In that embodiment, the operational data server(s) 110 store and provide operational data items including organizational information associated with that corporation (e.g., employee profile information, employee hierarchy information). In at least one embodiment, the operational data server(s) 110 is an FTP server that provides operational data items according to one or more protocols.

Additionally, the response data server(s) 112 stores and provides response data items. For example, in one embodiment, the response data server(s) 112 stores and provides response data items corresponding to one or more digital surveys distributed to a number of survey takers and sponsored by a user of the administrator device 114. For example, in one embodiment (as mentioned above), the administrator device 114 is associated with the corporation with a number of employees. In that embodiment, the corporation sponsors a digital survey (e.g., an employee satisfaction survey), and the response data server(s) 112 stores response data items including response information relative to that digital survey. In one or more embodiments, the response data server(s) 112 is a standalone server. Additionally or alternatively, the response data server(s) 112 is connected to or part of the digital survey system 104.

Although FIG. 1 illustrates a particular number and arrangement of the administrator device 114, the digital survey system 104, the intelligent data ingestion system 102, the operational data server(s) 110, and the response data server(s) 112, additional numbers and arrangements are possible. For example, in an alternative embodiment, the intelligent data ingestion system 102 receives operational data sets and/or response data sets from the administrator device 114. In yet another alternative embodiment, the intelligent data ingestion system 102 stores response data items (e.g., in the non-temporary data storage 108), and receives operation data items from the operational data server(s) 110.

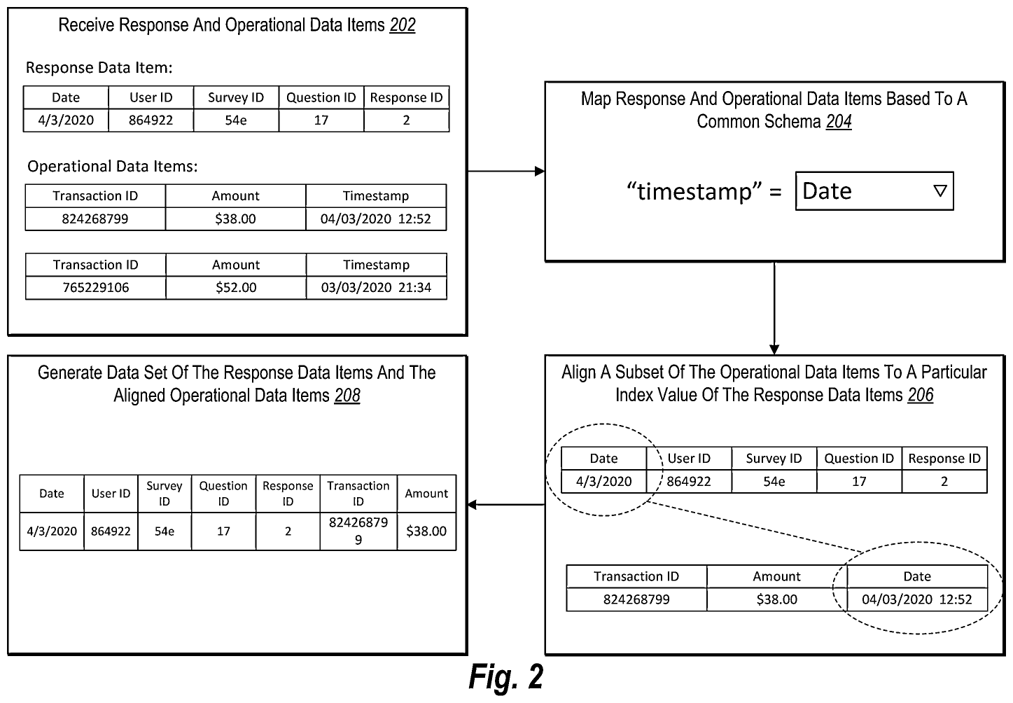

As mentioned above, the intelligent data ingestion system 102 generates a streamlined and targeted new data set during ingestion of original data sets based on alignments between data items in the original data sets. FIG. 2 illustrates an overview diagram of the intelligent data ingestion system 102 generating the new data set during ingestion. For example, as shown in FIG. 2, intelligent data ingestion system 102 performs an act 202 of receiving response and operational data items.

To illustrate, the intelligent data ingestion system 102 receives a first data set including response data items and a second data set including operational data items. In one or more embodiments, the intelligent data ingestion system 102 receives response data items from a server(s) or data source (e.g., the response data server(s) 112 as shown in FIG. 1) that is associated with the intelligent data ingestion system 102. Additionally or alternatively, the intelligent data ingestion system 102 receives response data items from a server or data source that is associated with a digital survey owner (e.g., via the administrator device 114). Furthermore, the intelligent data ingestion system 102 receives the second data set of operational data items from a server (e.g., the operational data server(s) 110) associated with the digital survey owner (e.g., via the administrator device 114).

In one or more embodiments, the intelligent data ingestion system 102 receives the response data items and the operational data items including different contents, formats, and syntaxes. For example, in one embodiment, the intelligent data ingestion system 102 receives response data items including, but not limited to, a number of indices for a date when the digital survey was completed, a user ID for the user who completed the digital survey, a survey ID unique to the digital survey, a question ID for a question in the digital survey, and a response ID for a particular response to that question selected by the user. The intelligent data ingestion system 102 further receives index values associated with each of the indices.

Additionally, in that embodiment, the intelligent data ingestion system 102 receives operational data items including a different number, type, and description of indices than those of the response data items. For example, the intelligent data ingestion system 102 receives operational data items including transactional data such as, but not limited to, a transaction ID for an individual transaction, an amount spent in that transaction, and a date of that transaction, along with associated index values.

The intelligent data ingestion system 102 further performs an act 204 of mapping response and operational data items based on a common schema. In one or more embodiments, and to enable combining separate data sets, the intelligent data ingestion system 102 maps indices of the data items within those data sets to a common schema. For example, the intelligent data ingestion system 102 determines that an index (e.g., “timestamp”) maps to a canonical index (e.g., “date”) from a common schema. The intelligent data ingestion system 102 can further map other indices of one or more of the data sets to the common schema. In one or more embodiments, the intelligent data ingestion system 102 maps indices of the data sets in response to one or more user selections via one or more user interfaces. Additionally or alternatively, the intelligent data ingestion system 102 can automatically map indices utilizing one or more computer learning models, knowledge trees, heuristics, rules, and so forth.

The intelligent data ingestion system 102 also performs an act 206 of aligning a subset of the operational data items to a particular index value of the response data items. In one or more embodiments, the intelligent data ingestion system 102 aligns the operational data items to the particular index value by determining the index associated with the response data items. The intelligent data ingestion system 102 then analyzes the operational data items to identify a subset of the operational data items that include index values at the determined index that correspond to index values at the determined index in the response data items. As part of this analysis, the intelligent data ingestion system 102 utilizes a mapping that indicates how indices of the operational data values correspond to indices of the response data items.

To illustrate, in one example, the intelligent data ingestion system 102 receives a detected selection or makes an automatic determination of an index value associated with an index of a response data item including a specific date (e.g., index value “Apr. 3, 2020” of index “Date”). The intelligent data ingestion system 102 then aligns one or more operational data items across that index value by identifying operational data items with corresponding index values (e.g., “Apr. 3, 2020 12:52”) at the corresponding index (e.g., “Date”).

In additional embodiments, the intelligent data ingestion system 102 aligns the operational data items and response data items across more than one index value. To illustrate, in one embodiment, the intelligent data ingestion system 102 can aligns the operational data items and response data items across “Date” and “user ID” indices. In at least one embodiment, the intelligent data ingestion system 102 utilizes machine learning or other heuristics to determine that an index value of an operational data item corresponds to the determined index value of the response data item(s). For example, the intelligent data ingestion system 102 utilizes machine learning or other rules to determine that an index value including the username “John Joseph Owens” in an operational data item matches or corresponds to the index value including the username “John Owens” in a response data item.

In response to aligning the subset of the operational data items to the response data items, the intelligent data ingestion system 102 performs an act 208 of generating a data set of the response data items and the aligned operational data items. For example, the intelligent data ingestion system 102 generates this new data set including unique index values and corresponding indices from the response data items and subset of the operational data items. To illustrate, in response to aligning transactional information in operational data items and survey information in response data items across dates, the intelligent data ingestion system 102 generates a new data set including data items that include survey information and transactional information that are associated with the same dates. In at least one embodiment, if an operational data item does not align with any of the response data items, the intelligent data ingestion system 102 disregards that operational data item.

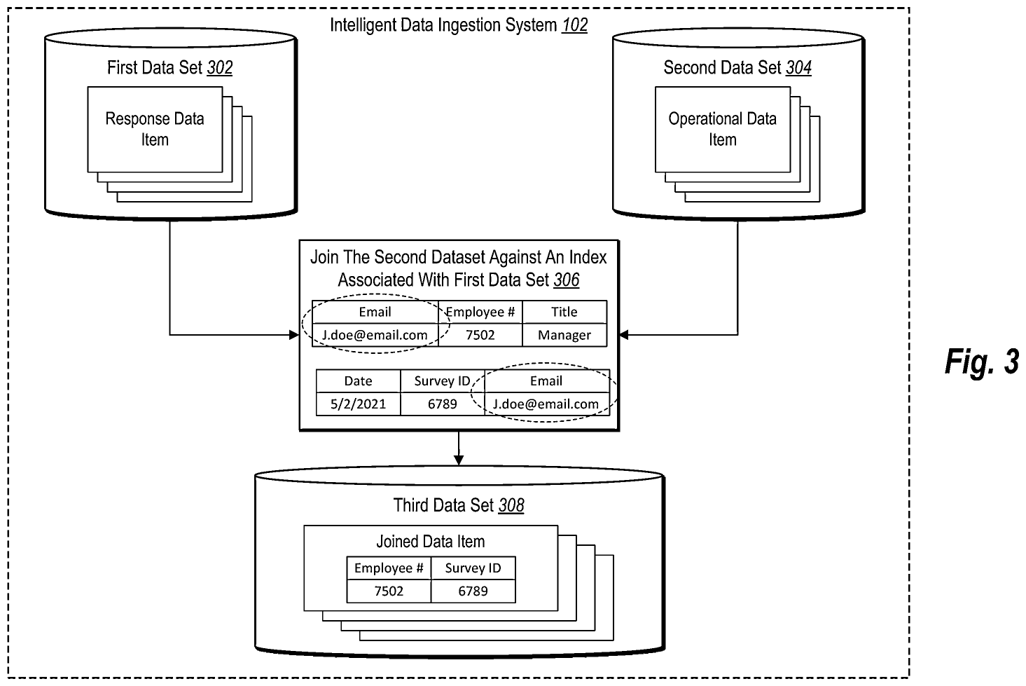

As discussed above, the intelligent data ingestion system 102 generates a new data set including index values of data items from two or more aligned data sets. FIG. 3 illustrates a sequence diagram of the intelligent data ingestion system 102 generating a third data set including response data items of a first data set and a subset of operational data items of a second data set. For example, as shown in FIG. 3 (and as discussed above with regard to FIG. 2), the intelligent data ingestion system 102 receives a first data set 302 of response data items, and a second data set 304 of operational data items. As discussed above, the response data items and the operational data items may include different numbers and types of indices. Furthermore, the index values associated with those indices may include different types, lengths, and formats of data.

As shown in FIG. 3, the intelligent data ingestion system 102 performs an act 306 of joining the second data set against an index associated with the first data set to generate the third data set 308. In more detail, the intelligent data ingestion system 102 performs the act 306 by joining the first and second data sets utilizing a particular index of the data items in the first data set 302 as a join key. For example, in one embodiment, the intelligent data ingestion system 102 performs a join operation in connection with the first data set 302 and the second data 304 by first determining a particular index of the data items in the first data set 302 to use as the join key. In one or more embodiments, the intelligent data ingestion system 102 determines the particular index in response to receiving a user indication of the particular index. For instance, the intelligent data ingestion system 102 receives a detected selection of a user interface element associated with the particular index, or receives other user input (e.g., textual input) indicating the particular index.

Additionally or alternatively, the intelligent data ingestion system 102 determines the particular index automatically. For example, in one embodiment, the intelligent data ingestion system 102 utilizes artificial intelligence (e.g., a trained machine learning model) to predict an index of the data items in the first data set 302 to use as the join key. Alternatively, the intelligent data ingestion system 102 can automatically determine the particular index by determining that an index of the data items of the first data set 302 is within a threshold level of similarity with an index of the data items of the second data set 304. For example, the intelligent data ingestion system 102 can automatically determine that an index “Date” of the data items in the first data set 302 is within a threshold level of similarity with an index “Timestamp” of the data items in the second data set 304. Based on this determined similarity, the intelligent data ingestion system 102 can determine that the index “Date” is the join key.

In response to determining an index of the data items of the first data set 302 to utilize as the join key, the intelligent data ingestion system 102 joins the first data set 302 and the second data set 304 based on the join key. For example, the intelligent data ingestion system 102 joins the second data set 304 against the join key of the first data set 302 by identifying data items in the second data set 304 with join key index values (e.g., index values at the index that correlates with the determined join key) that match index values at the join key index of the first data set 302.

To illustrate, in one example, the intelligent data ingestion system 102 receives the first data set 302 including the data items shown in Table 1.

TABLE 1

| Email | Survey ID | Date |
|---|---|---|
| John.doe@email.com | 6789 | Feb. 10, 2021 |
| James.smith@email.com | 6789 | Feb. 10, 2021 |
| Janet.johnson@email.com | 3241 | Feb. 13, 2021 |
| Jackson.taylor@email.com | 6789 | Feb. 11, 2021 |

The intelligent data ingestion system 102 further receives the second data set 304 including the data items shown in Table 2.

TABLE 2

| Email | Employee # | Job Title |
|---|---|---|
| Adam.lee@email.com | 1304 | Receptionist |
| John.doe@email.com | 7502 | Account Manager |
| Cynthia.jones@email.com | 5293 | HR Director |
| James.smith@email.com | 4216 | Account Manager |
| Janet.johnson@email.com | 2214 | Sales Executive |
| Jackson.taylor@email.com | 1456 | CEO |

In this example, the intelligent data ingestion system 102 further determines the join key associated with the first data set 302 is the index “Email.” Based on this join key, the intelligent data ingestion system 102 further joins the first data set 302 and the second data set 304 by identifying data items in the second data set 304 that correlate with the first data set 302 across the determined join key. In at least one embodiment, the intelligent data ingestion system 102 generates a resulting third data set 308 of joined data items as shown in Table 3.

TABLE 3

| | Survey | | Employee | Job |
|---|---|---|---|---|
| Email | ID | Date | # | Title |
| John.doe@email.com | 6789 | Feb. 10, | 7502 | Account |
| | | 2021 | | Manager |
| James.smith@email.com | 6789 | Feb. 10, | 4216 | Account |
| | | 2021 | | Manager |
| Janet.johnson@email.com | 3241 | Feb. 13, | 2214 | Sales |
| | | 2021 | | Executive |
| Jackson.taylor@email.com | 6789 | Feb. 11, | 1456 | CEO |
| | | 2021 | | |

As shown in Table 3, the intelligent data ingestion system 102 generates the third data set 308 including the data items from the first data set 302 enriched with additional related index values from the second data set 304.

In one or more embodiments, the intelligent data ingestion system 102 joins data sets in various ways. For example, in a preferred embodiment, the intelligent data ingestion system 102 performs a left-outer join to generate the third data set 308 including all of the response data items in the first data set 302 and a subset of the operational data items in the second data set 304 of those operational data items with index values correlated to those of the response data items across the join key. In an additional or alternative embodiment, the intelligent data ingestion system 102 performs an inner join to generate the third data set 308 including a subset of both the first data set 302 and the second data set 304 of only those response data items and operation data items correlated with each other across the join key. Additionally or alternatively, the intelligent data ingestion system 102 performs a right-outer join to generate the third data set 308 including all of the second data set 304 and a subset of the first data set 302 of response data items correlated with those of the operational data items across the join key. Additionally or alternatively, the intelligent data ingestion system 102 performs a full-outer join to generate the third data set 308 including all of the first data set 302 and all of the second data set 304 merged into a single data set (e.g., the third data set 308).

In one or more embodiments, the intelligent data ingestion system 102 generates the third data set 308 including selected indices of the first data set 302 and the second data set 304. For example, in one embodiment, the intelligent data ingestion system 102 receives user input specifying one or more indices (e.g., columns) of the data items in the first data set 302 and/or the second data set 304. Thus, in generating the third data set 308, the intelligent data ingestion system 102 determines data items in the first data set 302 and the second data set 304 to join across the determined index (e.g., the join key), and then generates the third data set 308 of joined data items including the index values and the selected indices.

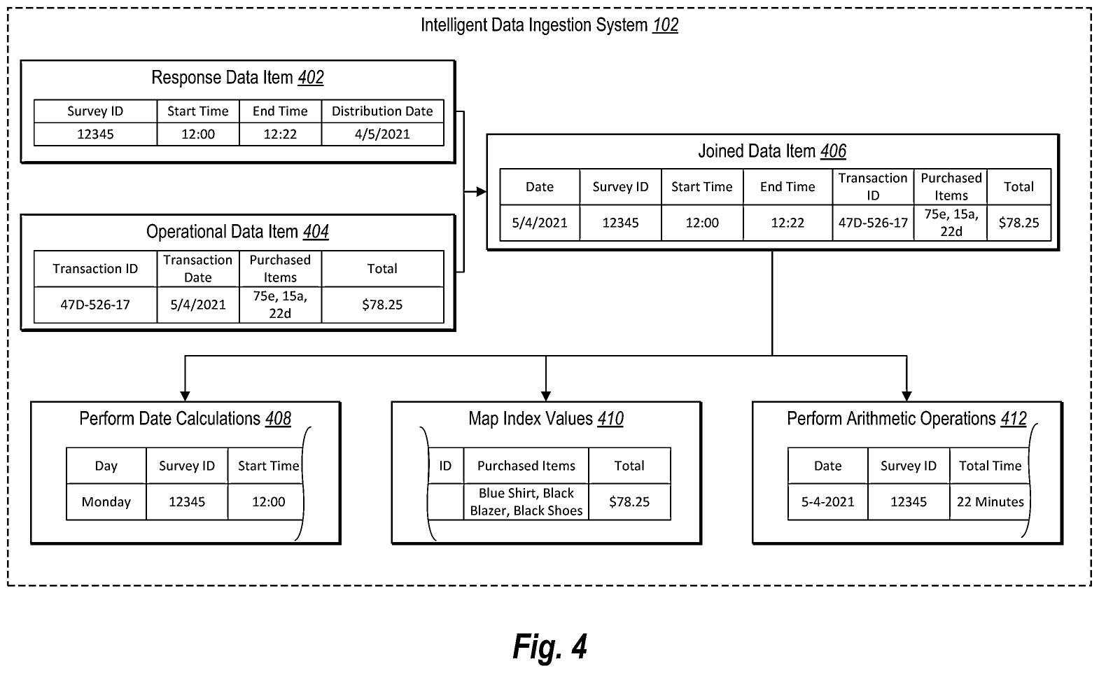

In one or more embodiments, the intelligent data ingestion system 102 performs additional operations on the joined data items in the generated third data set 308. For example, FIG. 4 illustrates schematic diagram of the intelligent data ingestion system 102 performing additional operations including date calculations, value mapping, and arithmetic operations in connection with a joined data item of the generated third data set 308. For instance, as shown, the intelligent data ingestion system 102 generates a joined data item 406 including index values of a response data item 402 and an operational data item 404 joined across a particular index of the response data item 402 (e.g., “Distribution Date”).

In at least one embodiment, the intelligent data ingestion system 102 performs an act 408 of enacting one or more date calculations in connection with the joined data item 406. For example, the intelligent data ingestion system 102 performs one or more date calculations by one or more of: determining a day of the week corresponding to a date, or reformatting the date (e.g., to month-day-year, to day-month-year, to year-month-day). Additionally, the intelligent data ingestion system 102 can change the index associated with the date calculation (e.g., from “Date” to “Day”).

In additional or alternative embodiments, the intelligent data ingestion system 102 performs an act 410 of mapping one or more values within the joined data item 406. For example, in one embodiment, the intelligent data ingestion system 102 maps values according to an additional file or database. To illustrate, the intelligent data ingestion system 102 can map identifiers (e.g., purchased item identifiers) to corresponding descriptive strings (e.g., such as “blue shirt,” “black blazer,” “black shoes”) based on information from another data source (e.g., an inventory database). Thus, the resulting modified joined data item 406 includes information that is more contextually descriptive.

In additional or alternative embodiments, the intelligent data ingestion system 102 performs an act 412 of enacting one or more arithmetic operations in connection with the joined data item 406. For example, in at least one embodiment, the intelligent data ingestion system 102 performs arithmetic operations that add, subtract, multiply, or divide an index value by a predetermined or user-selected amount. In another embodiment, the intelligent data ingestion system 102 performs arithmetic operations that combine two or more index values of the joined data item 406. For example, in one embodiment, the intelligent data ingestion system 102 combines a start time index value and an end time index value associated with a digital survey to determine a total time spent in completing the digital survey (e.g., “end time” minus “start time” equals “total time”). In that embodiment, the intelligent data ingestion system 102 can modify the joined data item 406 to remove the combined indices and add a new index associated with the new index value resulting from the combination.

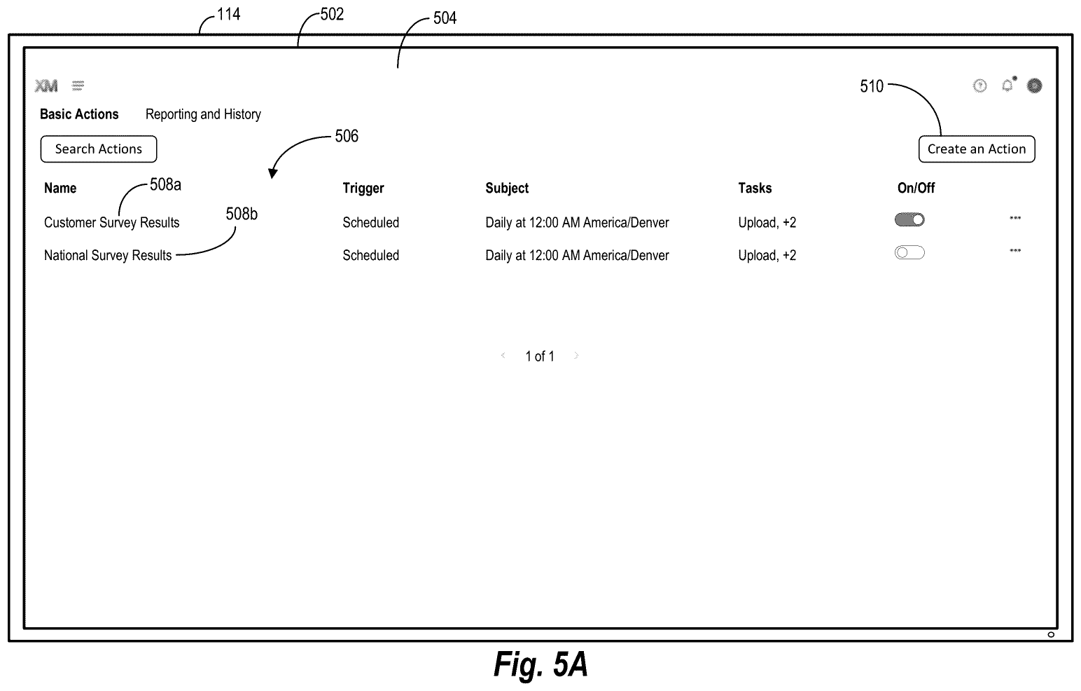

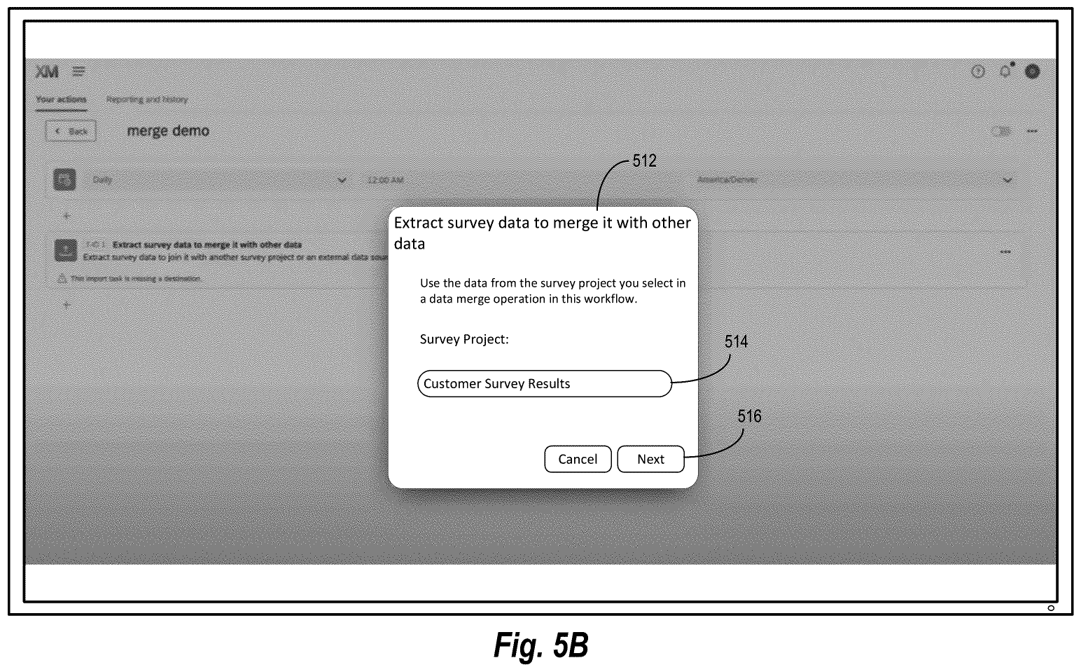

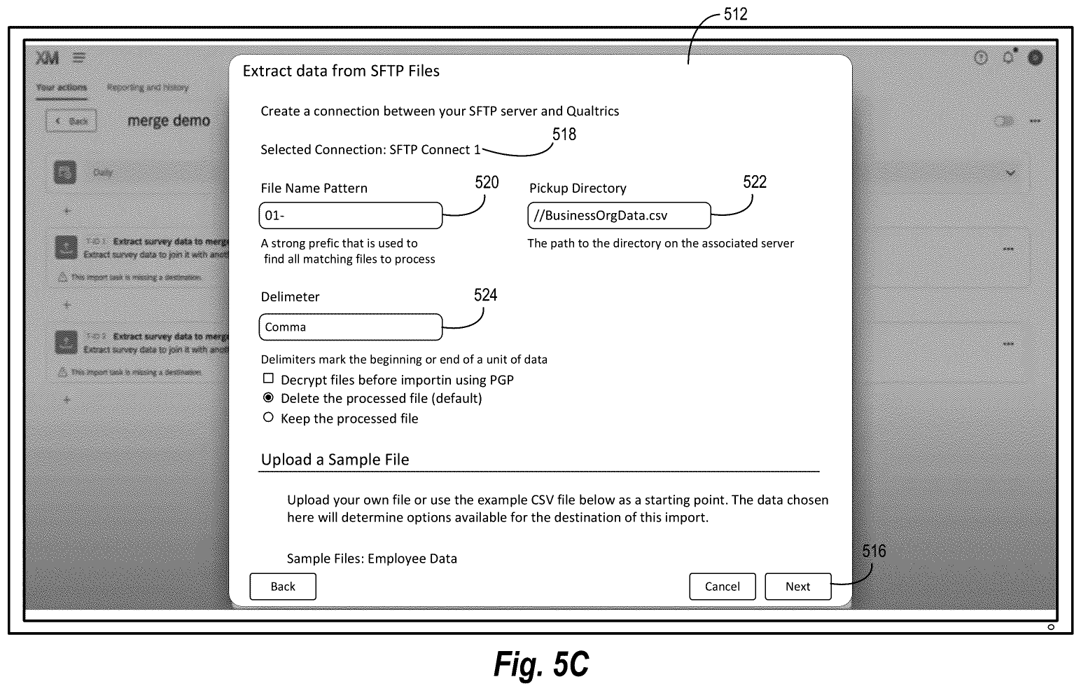

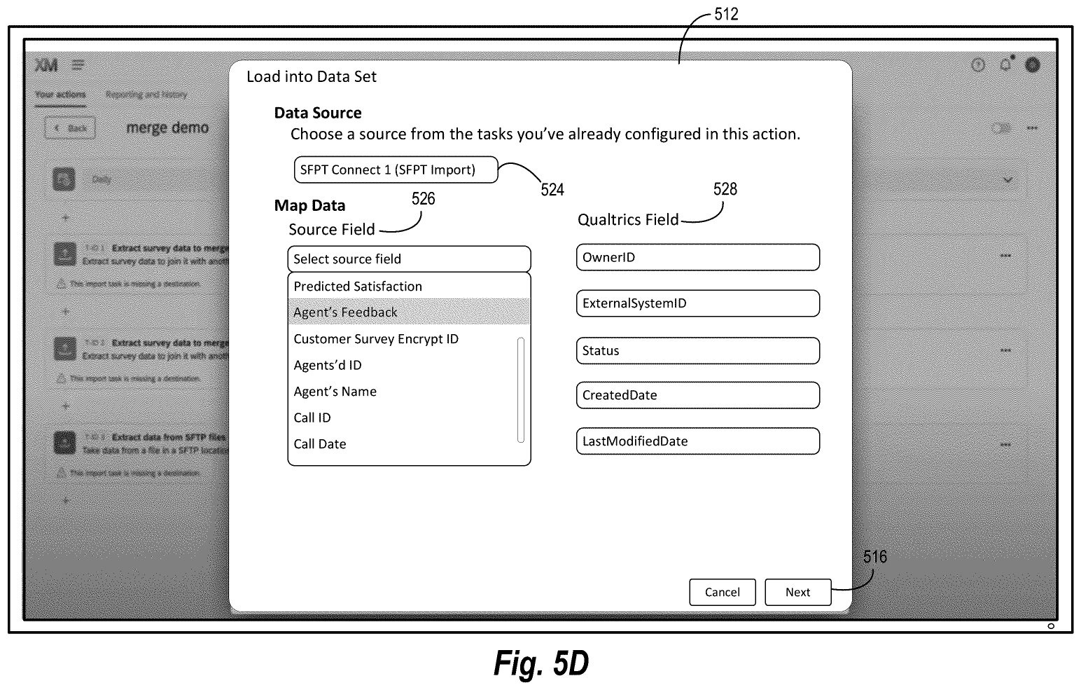

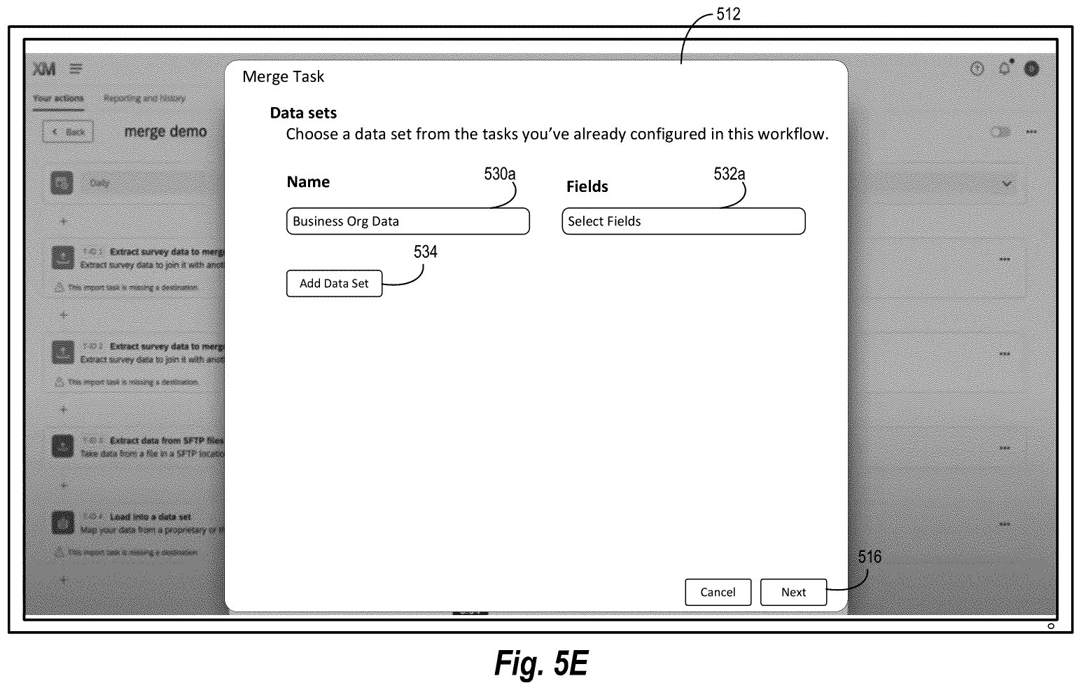

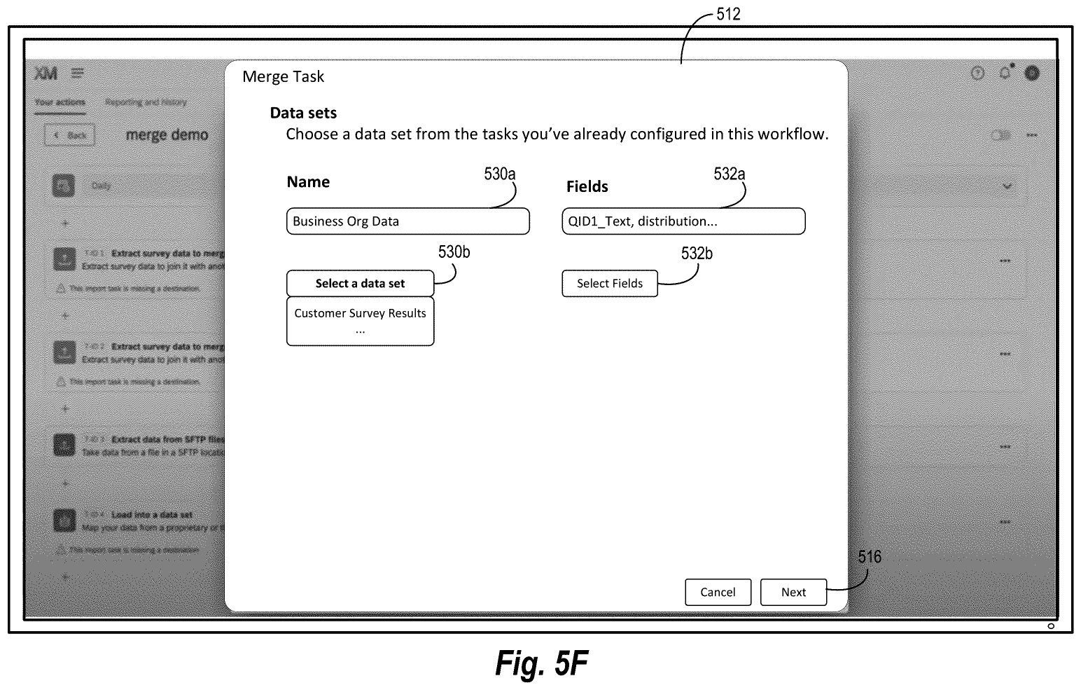

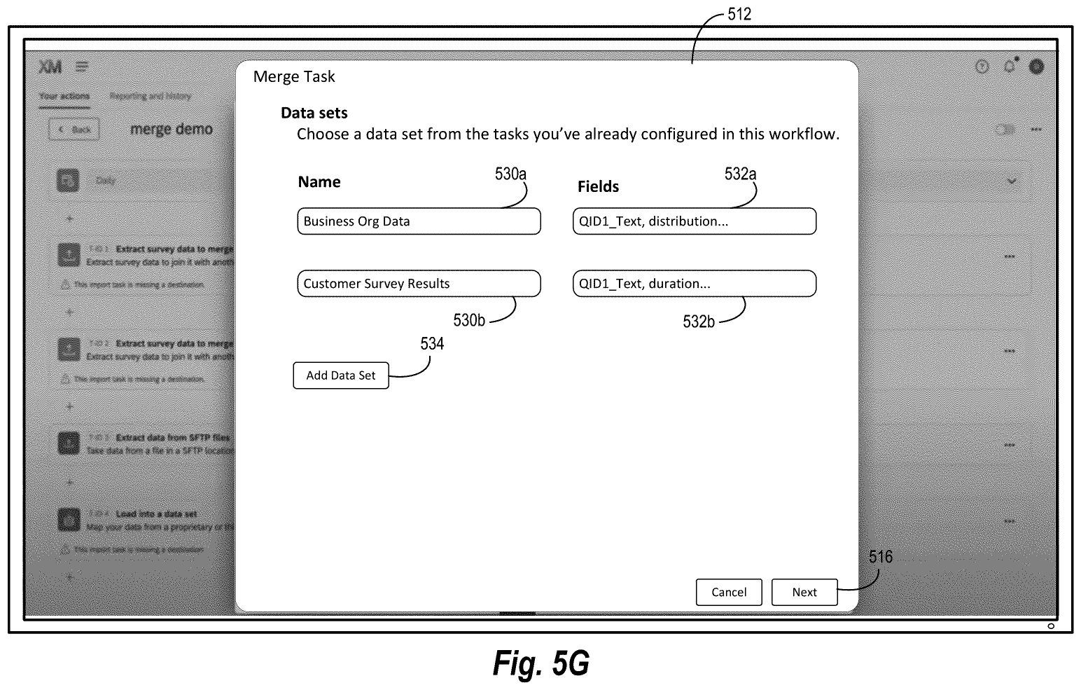

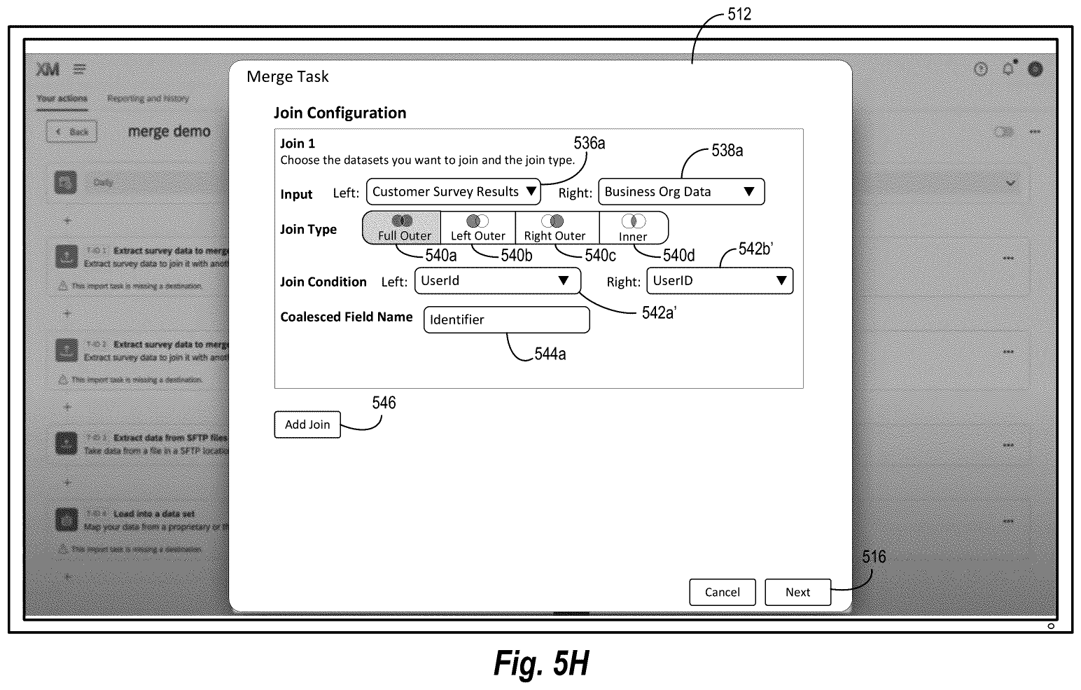

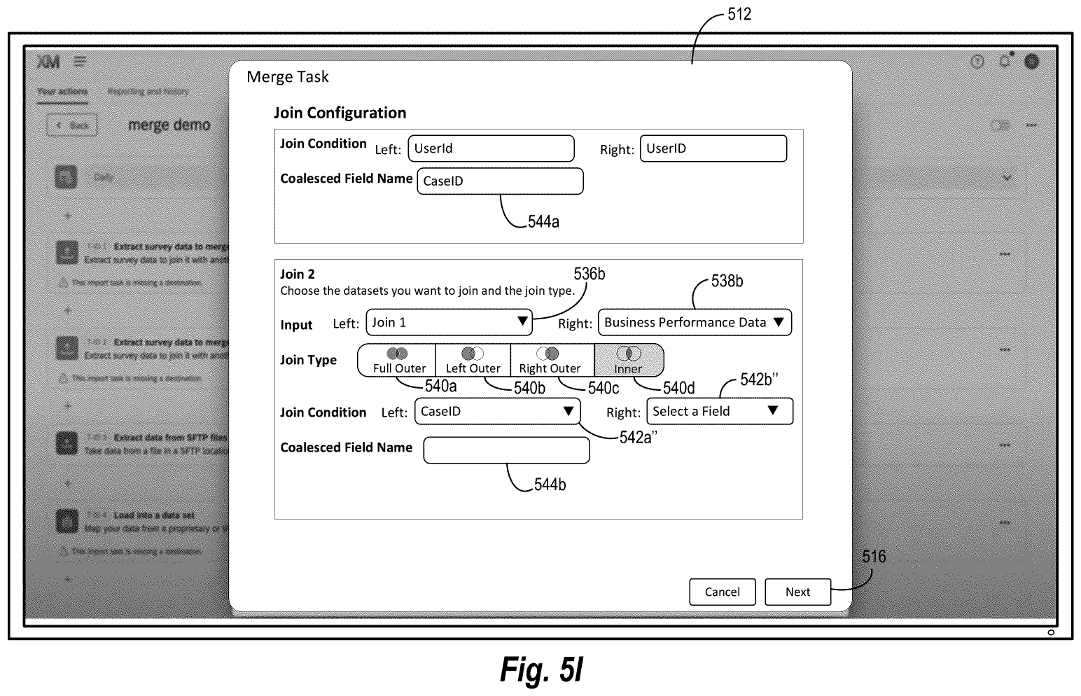

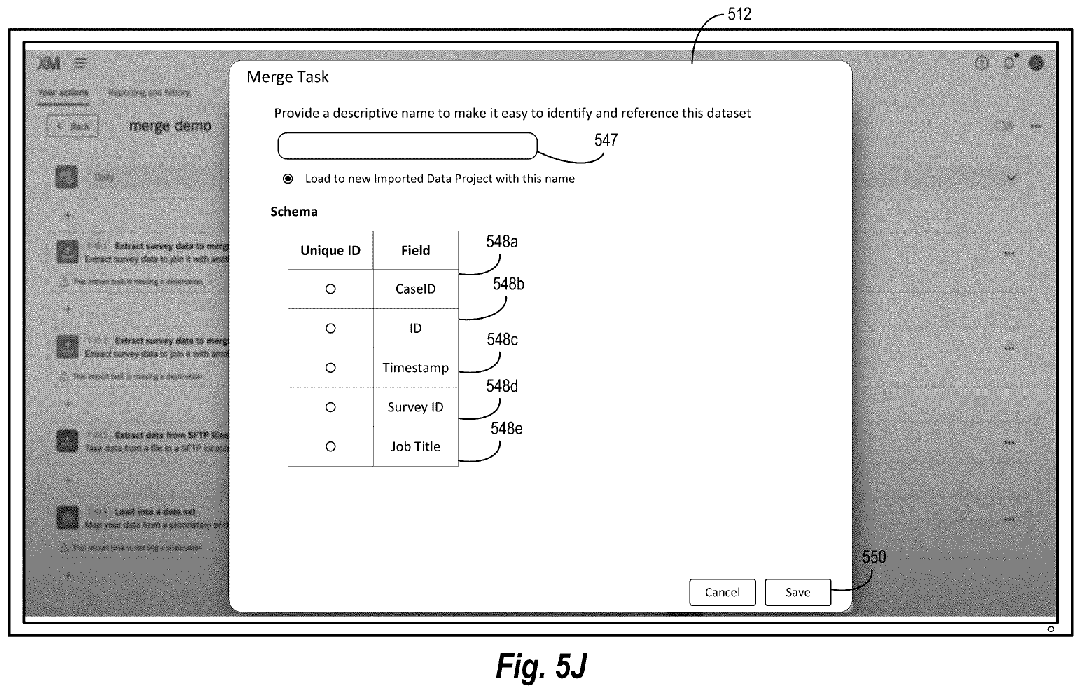

As mentioned above, the intelligent data ingestion system 102 provides a user interface that enables an administrator to configure parameters for generation of the third data set during ingestion of at least first and second data sets. FIGS. 5A-5J illustrate the intelligent data ingestion system 102 generating and providing ingestion tools for configuring the generation of a new data set during data ingestion. To illustrate, as shown in FIG. 5A, the digital survey system 104 provides a survey data set user interface 504 on a display 502 of the administrator device 114. As shown, the survey data set user interface 504 includes a list 506 of survey result data set controls 508a, 508b. For example, each of the survey result data set controls 508a, 508b is associated with a data set of response data items corresponding to a digital survey distributed to multiple survey takers. To illustrate, the response data items associated with the data set corresponding to the survey result data set control 508a (e.g., “Customer Survey Results) include information collected by the digital survey system 104 following distribution of a customer survey to multiple survey takers.

In one or more embodiments, the digital survey system 104 provides the survey result data set controls 508a, 508b in the list 506 in response to determining that the corresponding data sets are available for one or more actions or tasks. For example, the digital survey system 104 determines that the corresponding data sets are received in temporary storage associated with the digital survey system 104. Even though the corresponding data sets are received in temporary storage, however, they are not available for further analytical tasks until the intelligent data ingestion system 102 ingests at least a subset of those data sets into non-temporary storage.

As discussed above, in one or more embodiments, the intelligent data ingestion system 102 ingests response data items in combination with operational data items to enrich and otherwise enhance analysis of the response data items. For example, in response to selecting the button 510, the intelligent data ingestion system 102 generates an ingestion configuration user interface 512, as shown in FIG. 5B. As shown in FIG. 5B, the intelligent data ingestion system 102 initially generates the ingestion configuration user interface 512 including a response data selection dropdown 514. In one or more embodiments, the intelligent data ingestion system 102 populates the response data selection dropdown 514 with indicators of the data sets of response data items that are available for further actions (e.g., the same data sets associated with the survey result data set controls 508a, 508b). As shown in FIG. 5B, in some embodiments, the intelligent data ingestion system 102 generates the ingestion configuration user interface 512 as an overlay positioned on top of another user interface. In additional or alternative embodiment, the intelligent data ingestion system 102 generates the ingestion configuration user interface 512 as a full-display user interface.

In response to a detected selection of an indicator within the response data selection dropdown 514 followed by a detected selection of a next button 516, the intelligent data ingestion system 102 updates the ingestion configuration user interface 512 to enable further configuration of ingestion of one or more data sets. For example, as shown in FIG. 5C, the intelligent data ingestion system 102 updates the ingestion configuration user interface 512 with one or more controls for configuring a connection to at least one file server in order to receive a data set of operational data items. In one or more embodiments, as discussed above, the intelligent data ingestion system 102 receives a data set of operational data items from a file server (e.g., the operational data server(s) 110) associated with the administrator device 114.

Accordingly, the intelligent data ingestion system 102 updates the ingestion configuration user interface 512 to include a connection control 518 wherein a user can select an existing connection to a file server (e.g., “SFTP Connect 1”), a file name pattern text box 520 where the user can input a prefix that the intelligent data ingestion system 102 appends to the front end of data sets received via the file server connection, a pickup directory text box 522 wherein the user specifies the path to the directory on the file server where the desired operational data items are stored, and a delimiter selection dropdown 524 where the user selects a delimiter type associated with a data set received from the file server (e.g., comma delimited, carriage return delimited). In at least one embodiment, the intelligent data ingestion system 102 updates the ingestion configuration user interface 512 to include additional controls associated with decryption of received data sets from the file server, deletion options associated with the processed file, and options for uploading a sample file (e.g., to test the connection to the file server).

After receiving configurations via the controls 518-524 and in response to a detected selection of the next button 516, the intelligent data ingestion system 102 again updates the ingestion configuration user interface 512 to include one or more mapping controls, as shown in FIG. 5D. As discussed above, the intelligent data ingestion system 102 receives operational data items in any of a variety of formats with non-canonical indices (e.g., column headings). Thus, and to enable further ingestion in combination with response data items, the intelligent data ingestion system 102 maps the non-canonical indices of the operational data items to canonical indices based on detected selections via the ingestion configuration user interface 512. For example, the intelligent data ingestion system 102 updates the ingestion configuration user interface 512 to include a file server selection dropdown 524. In response to a detected selection of a configured file server connection (e.g., configured in response to the controls illustrated in FIG. 5C) via the file server selection dropdown 524, the intelligent data ingestion system 102 populates a source field column 526 with indices from a data set of operational data items received or accessed by way of the selected file server connection.

In response to detected selections of one or more non-canonical indices in the source field column 526 and one or more indices in a canonical field column 528, the intelligent data ingestion system 102 maps non-canonical indices from the data set of operational data items to canonical indices according to a common schema. For example, in response to a detected selection of an index “Agent's ID” in the source field column 526 followed by a detected selection of an index “ownerld” in the canonical field column 528, the intelligent data ingestion system 102 maps the non-canonical “Agent's ID” index to the canonical “ownerld” index. In at least one embodiment, the intelligent data ingestion system 102 receives additional selections via the columns 526, 528 to map some or all of the non-canonical indices to canonical indices.

In response to a detected selection of the next button 516, the intelligent data ingestion system 102 again updates the ingestion configuration user interface 512 to include additional controls whereby the user may select two or more data sets for ingestion into non-temporary storage. For example, as shown in FIG. 5E, the intelligent data ingestion system 102 updates the ingestion configuration user interface 512 to include a data set selection dropdown 530a. In one or more embodiments, the intelligent data ingestion system 102 populates the data set selection dropdown 530a with titles of data sets selected via response data selection dropdown 514 (e.g., shown in FIG. 5B) and indicated via the pickup directory text box 522 (e.g., shown in FIG. 5C). In response to a selection via the data set selection dropdown 530a (e.g., “Business Org Data”), the intelligent data ingestion system 102 further populates a fields selection dropdown 532a with the schematized (e.g., mapped) indices of the selected data set.

In response to a detected selection of an add data set button 534, the intelligent data ingestion system 102 updates the ingestion configuration user interface 512 to include another data set selection dropdown 530b and corresponding fields selection dropdown 532b, as shown in FIG. Utilizing the data set selection dropdown 530b and the fields selection dropdown 532b, the user can configure another data set for ingestion in combination with the data set configured via the data set selection dropdown 530a and the fields selection dropdown 532a, as shown in FIG. 1n additional or alterative embodiments, the intelligent data ingestion system 102 allows for additional data sets to be configured via additional data set selection dropdowns and corresponding fields selection dropdowns in response to additional detected selections of the add data set button 534.

With the data sets selected (e.g., “Customer Survey Results” data set of response data items and “Business Org Data” data set of operational data items), the intelligent data ingestion system 102 allows for further configuration of criteria for combining the data sets during ingestion. For example, in response to a detected selection of the next button 516, the intelligent data ingestion system 102 again updates the ingestion configuration user interface 512 to include one or more merge controls. For instance, as shown in FIG. 5H, the intelligent data ingestion system 102 updates the ingestion configuration user interface 512 to include a left-join data set dropdown 536a and a right-join data set dropdown 538a. The intelligent data ingestion system 102 also updates the ingestion configuration user interface 512 to include join type selectors 540a, 540b, 540c, and 540d, as well as a join key selection dropdowns 542a′, 542b′.

In one or more embodiment, the intelligent data ingestion system 102 receives user selections via the left-join data set dropdown 536a, the right-join data set dropdown 538a, the join type selectors 540a-540d, and the join key selection dropdowns 542a′, 542b′ to configure how two data sets are combined during data ingestion. For example, the intelligent data ingestion system 102 populates the left-join data set dropdown 536a and the right-join data set dropdown 536b with the data sets selected via the controls presented in the ingestion configuration user interface illustrated in FIG. 5G. In one or more embodiments, the intelligent data ingestion system 102 identifies the data sets selected in the left-join data set dropdown 536a and the right-join data set dropdown 536b as the data sets for selective combination during ingestion.

The intelligent data ingestion system 102 further receives configuration of the type of combination to perform on the selected data sets via one of the join type selectors 540a-540d. For example, as discussed above, the intelligent data ingestion system 102 performs one of a full-outer join of the selected data sets in response to a selection of the join type selector 540a, a left-outer join of the selected data sets in response to a selection of the join type selector 540b, a right-outer join of the selected data sets in response to a selection of the join type selector 540c, or an inner join of the selected data sets in response to a selection of the join type selector 540d

In one or more embodiments, the intelligent data ingestion system 102 determines the index (e.g., the join key) to join the data sets against based on the detected selections via the join key selection dropdowns 542a′, 542b′. For example, the intelligent data ingestion system 102 determines to join the selected data sets according to the selected join type selector 540a-540d where the selected index in the join key selection dropdown 542b′ matches the selected index in the join key selection dropdown 542a′. Additionally, the intelligent data ingestion system 102 optionally titles the resulting index of the data items in the new third data set according to the user input received via a coalesced field name text box 544a.

In at least one embodiment, the intelligent data ingestion system 102 performs multiple and complex combinations during ingestion of the same data sets. For example, in response to a detected selection of an add join button 546, the intelligent data ingestion system 102 updates the ingestion configuration user interface 512 to include additional configuration options for a second combination task, as shown in FIG. 5I. For example, the intelligent data ingestion system 102 updates the ingestion configuration user interface 512 to include a left-join data set dropdown 536b, a right-join data set dropdown 538b, the join type selectors 540a-540d, join key selection dropdowns 542a″, 542b″, and a coalesced field name text box 544b.

In one or more embodiments, as shown in FIG. 5I, the intelligent data ingestion system 102 populates the left-join data set dropdown 536b and the right-join data set dropdown 538b the same data set options as the left-join data set dropdown 536a and the right-join data set dropdown 538a in addition to an additional option including the output of the previous one or more joins. For example, in the configuration options for “Join 2,” the intelligent data ingestion system 102 populates the left-join data set dropdown 536b and the right-join data set dropdown 538b with an additional option for the output of “Join 1.” In this way, the intelligent data ingestion system 102 enables configuration of multiple nested and complex joins in sequence.

In response to a detected selection of the next button 516, the intelligent data ingestion system 102 updates the ingestion configuration user interface 512 with final configuration options. For example, as shown in FIG. 5J, the intelligent data ingestion system 102 updates the ingestion configuration user interface 512 to include the new data set name text box 546, and new data set index options 548a, 548b, 548c, 548d, and 548e. In one or more embodiments, the intelligent data ingestion system 102 titles the new data set generated in response to the combination according to the detected input via the new data set name text box 547. Additionally, the intelligent data ingestion system 102 includes the new data set index options 548a-548e corresponding to the indices of the selected data sets of response data items and operational data items. In at least one embodiment, the intelligent data ingestion system 102 generates the new data set including the indices corresponding to only the selected new data set index options 548a-548e.

In response to a detected selection of the save button 550, the intelligent data ingestion system 102 ingests the selected data sets according to the configurations received via the ingestion configuration user interface 512. For example, the intelligent data ingestion system 102 merges the first data set of response data items and the second data set of operational data items to generate the third data set of data item. The intelligent data ingestion system 102 then stores the new third data set in non-temporary data storage, and disregards any remaining data items of the first and second data sets not included in the new third data set. Additionally or alternatively, in response to a detected selection of the save button 550, the intelligent data ingestion system 102 stores the configurations received via the ingestion configuration user interface 512 for later use.

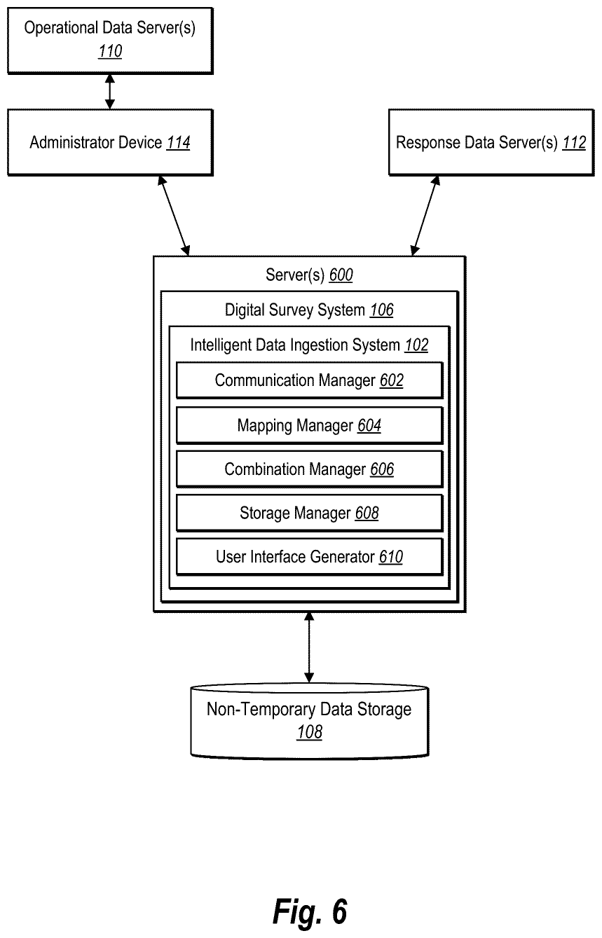

FIG. 6 illustrates a detailed schematic diagram of an embodiment 600 of the intelligent data ingestion system 102 in accordance with one or more embodiments. As discussed above, the intelligent data ingestion system 102 is operable on a variety of computing devices. Thus, for example, the intelligent data ingestion system 102 is operable on the server(s) 106 (as shown in FIG. 1). Additionally or alternatively, the intelligent data ingestion system 102 is operable on the administrator device 114. In one or more embodiments, the intelligent data ingestion system 102 includes a communication manager 602, a mapping manager 604, a combination manager 606, a storage manager 608, and a user interface generator 610.

As just mentioned, and as shown in FIG. 6, the intelligent data ingestion system 102 includes the communication manager 602. In one or more embodiments, the communication manager 602 performs all communication tasks involved in generating a targeted new data set for permanent storage during ingestion of other data sets. For example, the communication manager 602 receives configurations for generating a third data set according to user selections via the ingestion configuration user interface 512 as discussed above. The communication manager 602 further receives or otherwise accesses the first and second data sets. The communication manager 602 additionally communicates status updates regarding generating and storing the third data set to the administrator device 114.

As mentioned above, and as shown in FIG. 6, the intelligent data ingestion system 102 also includes the mapping manager 604. In one or more embodiments, the mapping manager 604 determines indices of received data sets, and maps non-canonical indices of the received data sets to canonical indices according to a predetermined schema. For example, in one embodiment, the mapping manager 604 generates a mapping that associates non-canonical indices with canonical indices. In another embodiment, the mapping manager 604 modifies or changes the non-canonical indices to the canonical indices in the data sets. In one or more embodiments, the mapping manager 604 maps indices according to one or more user selections via the ingestion configuration user interface 512 as discussed above.

As mentioned above, and as shown in FIG. 6, the intelligent data ingestion system 102 includes the combination manager 606. In one or more embodiments, the combination manager 606 generates a third data set according to the configurations received via the ingestion configuration user interface 512. For example, the combination manager 606 merges two or more data sets alone or in sequence. As discussed above, the combination manager 606 merges data sets according to at least one join type. Additionally or alternatively, the combination manager 606 combines data sets in other ways such as by combining select indices of the data sets into the third data set with no merge criteria.

As mentioned above, and as shown in FIG. 6, the intelligent data ingestion system 102 includes the storage manager 608. In one or more embodiments, the storage manager 608 stores and accesses a newly generated data set in non-temporary data storage. For example, in response to the combination manager 606 generating the third data set, the storage manager 608 stores the third data set in non-temporary data storage. Additionally, in response to receiving a segment query associated with the third data set, the storage manager 608 accesses the third data set to generate a response to the segment query. For example, the segment query may request a list of data items from the third data set that satisfy one or more criteria. Accordingly, the storage manager 608 accesses the third data set to identify the data items that satisfy the one or more criteria, and generates a response including the identified data items.

As mentioned above, and as shown in FIG. 6, the intelligent data ingestion system 102 includes the user interface generator 610. In one or more embodiments, the user interface generator 610 generates and updates the ingestion configuration user interface 512 as discussed above. For example, as shown above with regard to FIGS. 6A-6J, the user interface generator 610 generates the ingestion configuration user interface 512 including configuration options that are customized to selected data sets.

Each of the components 602-610 of the intelligent data ingestion system 102 includes software, hardware, or both. For example, the components 602-610 includes one or more instructions stored on a computer-readable storage medium and executable by processors of one or more computing devices, such as a client computing device or server device. When executed by the one or more processors, the computer-executable instructions of intelligent data ingestion system 102 causes the computing device(s) to perform the methods described herein. Alternatively, the components 602-610 includes hardware, such as a special-purpose processing device to perform a certain function or group of functions. Alternatively, the components 602-610 of the intelligent data ingestion system 102 includes a combination of computer-executable instructions and hardware.

Furthermore, the components 602-610 of the intelligent data ingestion system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 602-610 may be implemented as a stand-alone application, such as a desktop or mobile application. Furthermore, the components 602-610 may be implemented as one or more web-based applications hosted on a remote server. The components 602-610 may also be implemented in a suite of mobile device applications or “apps.”

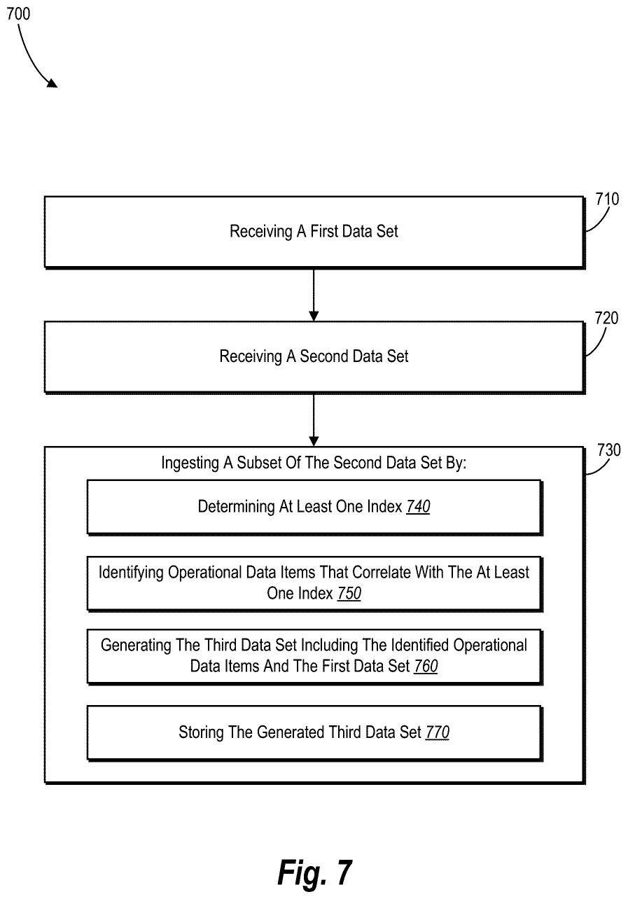

FIGS. 1-6, the corresponding text, and the examples provide a number of different methods, systems, devices, and non-transitory computer-readable media of the intelligent data ingestion system 102. In addition to the foregoing, one or more embodiments can also be described in terms of flowcharts comprising acts for accomplishing a particular result, as shown in FIG. 7. FIG. 7 may be performed with more or fewer acts. Further, the acts may be performed in differing orders. Additionally, the acts described herein may be repeated or performed in parallel with one another or parallel with different instances of the same or similar acts.

As mentioned, FIG. 7 illustrates a flowchart of a series of acts 700 for generating a third data set for non-temporary storage during ingestion of a first data set of response data items and a second data set of operational data items in accordance with one or more embodiments. While FIG. 7 illustrates acts according to one embodiment, alternative embodiments may omit, add to, reorder, and/or modify any of the acts shown in FIG. 7. The acts of FIG. 7 can be performed as part of a method. Alternatively, a non-transitory computer-readable medium can comprise instructions that, when executed by one or more processors, cause a computing device to perform the acts of FIG. 7. In some embodiments, a system can perform the acts of FIG. 7.

As shown in FIG. 7, the series of acts 700 includes an act 710 of receiving a first data set. In particular, the act 710 involves receiving a first data set comprising response data items associated with one or more digital surveys. For example, in one or more embodiments, the response data items in the first data set include one or more of: question information associated with the one or more digital surveys, response information associated with the one or more digital surveys, user-selected responses associated with the one or more digital surveys, user information associated with users who responded to questions from the one or more digital surveys, deployment information associated with the one or more digital surveys, and question flow information associated with the one or more digital surveys.

As shown in FIG. 7, the series of acts 700 includes an act 720 of receiving a second data set. In particular, the act 720 involves receiving a second data set comprising operational data items. For example, in one or more embodiments, the operational data items in the second data set are correlated with a sponsor of the one or more digital surveys and include one or more of profile information, contact information, corporate organization information, individual transaction date information, individual transaction user information, individual transaction amount information, and survey distribution statistics. In at least one embodiment, the series of acts 700 includes receiving the first data set form a first data source, and the second data set from a second data source.

Additionally, in one or more embodiments, receiving the first data set includes receiving the first data set in a first organization from a first data source, and receiving the second data set includes receiving the second data set in a second organization from a second data source, wherein the first organization is different from the second organization. For example, in one embodiment, the series of acts 700 includes, in response to receiving the first data set and receiving the second data set, organizing the response data items in the first data set and the operational data items in the second data set into a common schema comprising a plurality of indices.

Furthermore, in at least one embodiment, the series of acts 700 includes, in response to receiving the first data set and the second data set, converting the first data set and the second data set to a common schema comprising a plurality of indices. For example, in one embodiment, determining the at least one index associated with the first data set comprises determining a particular index of the converted first data set to join the converted second data set against.

As shown in FIG. 7, the series of acts 700 includes an act 730 of ingesting a subset of the second data set. In particular, the act 730 involves ingesting, into non-temporary data storage, a subset of the second data set based on a correspondence between the subset of the second data set and the first data set. More specifically, the act 730 involves ingesting, into non-temporary data storage, a subset of the second data set based on a correspondence between the subset of the second data set and the first data set by further performing acts 740, 750, 760, and 770 discussed below.

For example, as shown in FIG. 7, the series of acts 700 includes the act 740 of determining at least one index. In particular, the act 740 involves determining at least one index associated with the first data set. For example, in at least one embodiment, determining the at least one index associated with the first data set is in response to a detected user selection of the at least one index.

As shown in FIG. 7, the series of acts 700 includes an act 750 of identifying operational data items that correlate with the at least one index. In particular, the act 750 involves identifying a subset of the operational data items from the second data set that correlate with the at least one index. For example, in one or more embodiments, identifying the subset of operational data items from the second data set that correlate with the at least one index includes: aligning, based on the common schema, the response data items from first data set and the operational data items from the second data set across an index of the common schema, and identifying the aligned operational data items as the subset of operational data items from the second data set.

As shown in FIG. 7, the series of acts 700 includes an act 760 of generating the third data set including the identified operational data items and the first data set. In particular, the act 760 involves generating a third data set comprising the first data set and the subset of the operational data items from the second data set that correlate with the at least one index. For example, in at least one embodiment, generating the third data set includes: determining index values correlated with the particular index in the converted first data set; identifying operational data items in the converted second data set that comprise the index values correlated with the particular index in the converted second data set; and generating the third data set comprising the converted first data set and the identified operational data items from the converted second data set.

In more detail, generating the third data set can include: aligning the first data set and the second data set across the at least one index; identifying index values of the one or more response data items at the at least one index; identifying the one or more operational data items comprising the index values at the at least one index; and generating the third data set comprising the first data set and the one or more operational data items comprising the index values at the at least one index. In at least one embodiment, generating the third data set further includes disregarding operational data items in the second data set that do not comprise the data values at the at least one index.

As shown in FIG. 7, the series of acts 700 includes an act 770 of storing the generated third data set. In particular, the act 770 involves storing the generated third data set in the non-temporary data storage. In one or more embodiments, the series of acts 700 further includes receiving a segment query associated with the third data set and specifying one or more index values at one or more indices, and generating a query response to the segment query by identifying response data items and operational data items from the third data set that comprise the specified one or more index values at the one or more indices. For example, in one embodiment, the series of acts 700 includes receiving a query defining a subset of the third data set according to a plurality of specified index values at corresponding indices within the third data set, and generating a query response comprising at least one a response data items or an operational data item from the third data set that comprise the plurality of specified index values at the corresponding indices within the third data set.

In one or more embodiments, the series of acts 700 also includes further ingesting the subset of the second data set by transforming the third data set according to one or more of date calculations, value mappings, or arithmetic operations. Additionally, in at least one embodiment, the series of acts 700 includes receiving one or more user-selected indices associated with the first data set and one or more user-selected indices associated with the second data set. In that embodiment, generating the third data set is further based on the one or more user-selected indices associated with the first data set and the one or more user-selected indices associated with the second data set.

In one or more embodiments, the series of acts 700 includes receiving from a client device prior to ingesting the subset of the second data set, a user indication of the at least one index. In that embodiment, identifying the subset of the operational data items from the second data set that correlate with the at least one index includes: identifying index values correlated with the at least one index from the response data items, and identifying one or more operational data items including the index values at the at least one index.

Embodiments of the present disclosure can comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein can be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions can be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure can be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure can also be practiced in distributed system environments where local and remote computer systems, which are linked (either by hardwired data links, wireless data links, or by a combination of hardwired and wireless data links) through a network, both perform tasks. In a distributed system environment, program modules can be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 8 illustrates a block diagram of exemplary computing device 800 that can be configured to perform one or more of the processes described above. One will appreciate that one or more computing devices such as the computing device 800 can implement the various devices of the environment 100 of FIG. 1. As shown by FIG. 8, the computing device 800 can comprise a processor 802, a memory 804, a storage device 806, an I/O interface 808, and a communication interface 810, which can be communicatively coupled by way of a communication infrastructure 812. While an exemplary computing device 800 is shown in FIG. 8, the components illustrated in FIG. 8 are not intended to be limiting. Additional or alternative components can be used in other embodiments. Furthermore, in certain embodiments, the computing device 800 can include fewer components than those shown in FIG. 8. Components of the computing device 800 shown in FIG. 8 will now be described in additional detail.

In one or more embodiments, the processor 802 includes hardware for executing instructions, such as those making up a computer program. As an example and not by way of limitation, to execute instructions, the processor 802 can retrieve (or fetch) the instructions from an internal register, an internal cache, the memory 804, or the storage device 806 and decode and execute them. In one or more embodiments, the processor 802 can include one or more internal caches for data, instructions, or addresses. As an example and not by way of limitation, the processor 802 can include one or more instruction caches, one or more data caches, and one or more translation lookaside buffers (TLBs). Instructions in the instruction caches can be copies of instructions in the memory 804 or the storage 806.

The memory 804 can be used for storing data, metadata, and programs for execution by the processor(s). The memory 804 can include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 804 can be internal or distributed memory.

The storage device 806 includes storage for storing data or instructions. As an example and not by way of limitation, storage device 806 can comprise a non-transitory storage medium described above. The storage device 806 can include a hard disk drive (HDD), a floppy disk drive, flash memory, an optical disc, a magneto-optical disc, magnetic tape, or a Universal Serial Bus (USB) drive or a combination of two or more of these. The storage device 806 can include removable or non-removable (or fixed) media, where appropriate. The storage device 806 can be internal or external to the computing device 800. In one or more embodiments, the storage device 806 is non-volatile, solid-state memory. In other embodiments, the storage device 806 includes read-only memory (ROM). Where appropriate, this ROM can be mask programmed ROM, programmable ROM (PROM), erasable PROM (EPROM), electrically erasable PROM (EEPROM), electrically alterable ROM (EAROM), or flash memory or a combination of two or more of these.

The I/O interface 808 allows a user to provide input to, receive output from, and otherwise transfer data to and receive data from computing device 800. The I/O interface 808 can include a mouse, a keypad or a keyboard, a touch screen, a camera, an optical scanner, network interface, modem, other known I/O devices or a combination of such I/O interfaces. The I/O interface 808 can include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 808 is configured to provide graphical data to a display for presentation to a user. The graphical data can be representative of one or more graphical user interfaces and/or any other graphical content as can serve a particular implementation.

The communication interface 810 can include hardware, software, or both. In any event, the communication interface 810 can provide one or more interfaces for communication (such as, for example, packet-based communication) between the computing device 800 and one or more other computing devices or networks. As an example and not by way of limitation, the communication interface 810 can include a network interface controller (NIC) or network adapter for communicating with an Ethernet or other wire-based network or a wireless NIC (WNIC) or wireless adapter for communicating with a wireless network, such as a WI-FI.

Additionally, or alternatively, the communication interface 810 can facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As an example, the communication interface 810 can facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 810 can facilitate communications various communication protocols. Examples of communication protocols that can be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MIMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 812 can include hardware, software, or both that couples components of the computing device 800 to each other. As an example and not by way of limitation, the communication infrastructure 812 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 9 illustrates an example network environment 900 for the intelligent data ingestion system 102. Network environment 900 includes a client system 906, and a server device hosting a digital survey management system 902 connected to each other by a network 904. Although FIG. 9 illustrates a particular arrangement of client system 906, digital survey management system 902, and network 904, this disclosure contemplates any suitable arrangement of client system 906, digital survey management system, and network 904. As an example and not by way of limitation, two or more of client system 906, and digital survey management system can be connected to each other directly, bypassing network 904. As another example, two or more of client system 906 and digital survey management system can be physically or logically co-located with each other in whole, or in part. Moreover, although FIG. 9 illustrates a particular number of client devices 906, server devices 902, and networks 904, this disclosure contemplates any suitable number of client devices 906, server devices 902, and networks 904. As an example and not by way of limitation, network environment 900 can include multiple client devices 906, server devices 902, and networks 904.

This disclosure contemplates any suitable network 904. As an example and not by way of limitation, one or more portions of network 904 can include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 904 can include one or more networks 904.

Links can connect client system 906, and digital survey management system to communication network 904 or to each other. This disclosure contemplates any suitable links. In particular embodiments, one or more links include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 900. One or more first links can differ in one or more respects from one or more second links.

In particular embodiments, client system 906 can be an electronic device including hardware, software, or embedded logic components or a combination of two or more such components and capable of carrying out the appropriate functionalities implemented or supported by client system 906. As an example and not by way of limitation, a client system 906 can include any of the computing devices discussed above in relation to FIG. 9. A client system 906 can enable a network user at client system 906 to access network 904. A client system 906 can enable its user to communicate with other users at other client devices or systems.

In particular embodiments, client system 906 can include a web browser, such as MICROSOFT INTERNET EXPLORER, GOOGLE CHROME, or MOZILLA FIREFOX, and can have one or more add-ons, plug-ins, or other extensions, such as TOOLBAR or YAHOO TOOLBAR. A user at client system 906 can enter a Uniform Resource Locator (URL) or other address directing the web browser to a particular server (such as server, or a server associated with a third-party system), and the web browser can generate a Hyper Text Transfer Protocol (HTTP) request and communicate the HTTP request to server. The server can accept the HTTP request and communicate to client system 906 one or more Hyper Text Markup Language (HTML) files responsive to the HTTP request. Client system 906 can render a webpage based on the HTML files from the server for presentation to the user. This disclosure contemplates any suitable webpage files. As an example and not by way of limitation, webpages can render from HTML files, Extensible Hyper Text Markup Language (XHTML) files, or Extensible Markup Language (XML) files, according to particular needs. Such pages can also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser can use to render the webpage) and vice versa, where appropriate.

In particular embodiments, digital survey management system can include a variety of servers, sub-systems, programs, modules, logs, and data stores. In particular embodiments, digital survey management system can include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Digital survey management system can also include suitable components such as network interfaces, security mechanisms, load balancers, failover servers, management-and-network-operations consoles, other suitable components, or any suitable combination thereof.

In particular embodiments, digital survey management system can include one or more user-profile stores for storing user profiles. A user profile can include, for example, biographic information, demographic information, behavioral information, social information, or other types of descriptive information, such as work experience, educational history, hobbies or preferences, interests, affinities, or location. Interest information can include interests related to one or more categories. Categories can be general or specific

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments can be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A non-transitory computer-readable storage medium comprising instructions that, when executed by at least one processor, cause a computing device to:
receive a first data set comprising response data items associated with one or more digital surveys;
receive a second data set comprising operational data items; and
ingest, into non-temporary data storage, a subset of the second data set based on a correspondence between the subset of the second data set and the first data set by:
determining at least one index associated with the first data set;
identifying a subset of the operational data items from the second data set that correlate with the at least one index;
generating a third data set comprising the first data set and the subset of the operational data items from the second data set that correlate with the at least one index; and
storing the generated third data set in the non-temporary data storage.

2. The non-transitory computer-readable storage medium as recited in claim 1, wherein the response data items in the first data set comprise one or more of: question information associated with the one or more digital surveys, response information associated with the one or more digital surveys, user-selected responses associated with the one or more digital surveys, user information associated with users who responded to questions from the one or more digital surveys, deployment information associated with the one or more digital surveys, and question flow information associated with the one or more digital surveys.

3. The non-transitory computer-readable storage medium as recited in claim 1, wherein the operational data items in the second data set are correlated with a sponsor of the one or more digital surveys and comprise one or more of profile information, contact information, corporate organization information, individual transaction date information, individual transaction user information, individual transaction amount information, and survey distribution statistics.

4. The non-transitory computer-readable storage medium as recited in claim 1, further comprising instructions that, when executed by the at least one processor, cause the computing device to:
receive the first data set from a first data source; and
receive the second data set from a second data source.

5. The non-transitory computer-readable storage medium as recited in claim 1, further comprising instructions that, when executed by the at least one processor, cause the computing device to, in response to receiving the first data set and the second data set, convert the first data set and the second data set to a common schema comprising a plurality of indices.

6. The non-transitory computer-readable storage medium as recited in claim 5, wherein determining the at least one index associated with the first data set comprises determining a particular index of the converted first data set to join the converted second data set against.

7. The non-transitory computer-readable storage medium as recited in claim 6, wherein generating the third data set comprises:
determining index values correlated with the particular index in the converted first data set;
identifying operational data items in the converted second data set that comprise the index values correlated with the particular index in the converted second data set; and
generating the third data set comprising the converted first data set and the identified operational data items from the converted second data set.

8. A system comprising:
at least one processor; and
at least one non-transitory computer-readable storage medium storing instructions thereon that, when executed by the at least one processor, cause the system to:
receive a first data set comprising response data items associated with one or more digital surveys;
receive a second data set comprising operational data items; and
ingest, into non-temporary data storage, a subset of the second data set based on a corresponding between the subset of the second data set and the first data set by:
determining at least one index associated with the first data set;
identifying a subset of the operational data items from the second data set that correlate with the at least one index;
generating a third data set comprising the first data set and the subset of the operational data items from the second data set that correlate with the at least one index; and
storing the generated third data set in the non-temporary data storage.

9. The system as recited in claim 8, generating the third data set comprises:
aligning the first data set and the second data set across the at least one index;
identifying index values of the one or more response data items at the at least one index;
identifying the one or more operational data items comprising the index values at the at least one index; and
generating the third data set comprising the first data set and the one or more operational data items comprising the index values at the at least one index.

10. The system as recited in claim 9, wherein generating the third data set further comprises disregarding operational data items in the second data set that do not comprise the data values at the at least one index.

11. The system as recited in claim 8, further storing instructions thereon that, when executed by the at least one processor, cause the system to further ingest the subset of the second data set by transforming the third data set according to one or more of date calculations, value mappings, or arithmetic operations.

12. The system as recited in claim 8, further storing instructions thereon that, when executed by the at least one processor, cause the system to:
receive, from a client device prior to ingesting the subset of the second data set, a user indication of the at least one index; and
wherein identifying the subset of the operational data items from the second data set that correlate with the at least one index comprises:
identifying index values correlated with the at least one index from the response data items; and
identifying one or more operational data items comprising the index values at the at least one index.

13. The system as recited in claim 8, further storing instructions thereon that, when executed by the at least one processor, cause the system to receive one or more user-selected indices associated with the first data set and one or more user-selected indices associated with the second data set.

14. The system as recited in claim 13, wherein generating the third data set is further based on the one or more user-selected indices associated with the first data set and the one or more user-selected indices associated with the second data set.

15. The system as recited in claim 8, storing instruction thereon that, when executed by the at least one processor, further cause the system to:
receive the first data set by receiving the first data set in a first organization from a first data source; and
receive the second data set by receiving the second data set in a second organization from a second data source, wherein the first organization is different from the second organization.

16. The system as recited in claim 8, further storing instructions thereon that, when executed by the at least one processor, cause they system to:
receive a segment query associated with the third data set and specifying one or more index values at one or more indices; and
generate a query response to the segment query by identifying response data items and operational data items from the third data set that comprise the specified one or more index values at the one or more indices.

17. A method comprising:
receiving a first data set comprising response data items associated with one or more digital surveys;
receiving a second data set comprising operational data items; and
ingesting, into non-temporary data storage, a subset of the second data set based on a correspondence between the subset of the second data set and the first data set by:
determining at least one index associated with the first data set;
identifying a subset of the operational data items from the second data set that correlate with the at least one index;
generating a third data set comprising the first data set and the subset of the operational data items from the second data set that correlate with the at least one index; and
storing the generated third data set in the non-temporary data storage.

18. The method as recited in claim 17, further comprising, in response to receiving the first data set and receiving the second data set, organizing the response data items in the first data set and the operational data items in the second data set into a common schema comprising a plurality of indices.

19. The method as recited in claim 18, wherein identifying the subset of operational data items from the second data set that correlate with the at least one index comprises:
aligning, based on the common schema, the response data items from first data set and the operational data items from the second data set across an index of the common schema; and
identifying the aligned operational data items as the subset of operational data items from the second data set.

20. The method as recited in claim 19, further comprising:
receiving a query defining a subset of the third data set according to a plurality of specified index values at corresponding indices within the third data set; and
generating a query response comprising at least one a response data items or an operational data item from the third data set that comprise the plurality of specified index values at the corresponding indices within the third data set.
